(19) United States
(12) Patent Application Publication
(10) Pub. No.: US 2012/0064325 A1
(43) Pub. Date: Mar. 15, 2012

(54) DOUBLE-SIDED PRESSURE-SENSITIVE ADHESIVE SHEET

(75) Inventors: Hiroaki FUMOTO, Osaka (JP); Tomohide BANBA, Osaka (JP)

(73) Assignee: NITTO DENKO CORPORATION, Osaka (JP)

(21) Appl. No.: 13/231,666

(22) Filed: Sep. 13, 2011

(30) Foreign Application Priority Data
Sep. 14, 2010 (JP) 2010-205422

(51) Int. Cl. B32B 33/00; B32B 7/10

(52) U.S. Cl. 428/220; 428/354

(57) ABSTRACT

The present invention provides a pressure-sensitive adhesive sheet which is capable of shielding electromagnetic waves and has an excellent transparency. The pressure-sensitive adhesive sheet according to the present invention includes a conductive film and pressure-sensitive adhesive layers on both sides of the conductive film and has a total light transmittance of 80% or more and a haze of 5% or less, wherein at least one surface of the conductive film has a surface resistivity of 500Ω/□ or less. The conductive film preferably, includes a conductive layer and a film substrate layer. The double-sided pressure-sensitive adhesive sheet preferably has a thickness of 3 to 2,000 μm.

### BACKGROUND OF THE INVENTION

1. Technical Field

The present invention relates to a transparent pressure-sensitive pressure-sensitive adhesive sheet which is capable of shielding electromagnetic waves.

2. Background Art

Recently, in various fields, display devices such as liquid crystal displays (LCDs) or an input device used by combining with the display device, such as a touch panel, have been widely used. In manufacturing the display device or the input device, a pressure-sensitive adhesive sheet (pressure-sensitive adhesive tape) is used for laminating optical members. For example, the transparent pressure-sensitive adhesive sheet is used to laminate the touch panel and various display devices or optical members such as a protective plate (for example, see Patent Documents 1 to 3). Further, it is required that the pressure-sensitive adhesive sheet has high transparency from the standpoint of visibility of the display surface in a manufactured display device or input device.

In the display devices or input devices, there have been such cases where signals coming out of components composing the devices or electromagnetic waves from the outside have been noised to cause misoperations. For instance, there has been a case where signals coming out of a display module are noised to cause misoperation of a touch panel during sensing in the touch panel, particularly in an electric capacitive type touch panel. In order to prevent such phenomena, electromagnetic shielding characteristics are required.
Patent Document 1: JP 2003-238915 A
Patent Document 2: JP 2003-342542 A
Patent Document 3: JP 2004-231723 A

### SUMMARY OF THE INVENTION

The present invention provides a pressure-sensitive adhesive sheet which is capable of shielding electromagnetic waves and has excellent transparency.

The present inventors have intensively studied in order to solve the problems. As a result, the inventors have found that a pressure-sensitive adhesive sheet capable of shielding electromagnetic waves and having high transparency can be obtained by using a conductive film of which at least one surface has a low surface resistivity and allowing the pressure-sensitive adhesive sheet to have a total light transmittance of a predetermined value or more and a haze of a predetermined value or more, thereby completing the present invention.

Namely, the present invention provides a double-sided pressure-sensitive adhesive sheet, which has a conductive film and pressure-sensitive adhesive layers on both sides of the conductive film, and has a total light transmittance of 80% or more and a haze of 5% or less, wherein at least one surface of the conductive film has a surface resistivity of 500Ω/□ or less.

In the double-sided pressure-sensitive adhesive sheet, the conductive film preferably includes a conductive layer and a film substrate layer.

The double-sided pressure-sensitive adhesive sheet preferably has a thickness of 3 to 2,000 μm.

The double-sided pressure-sensitive adhesive sheet is preferably used for laminating an optical member.

The double-sided pressure-sensitive adhesive sheet of the present invention is capable of shielding electromagnetic waves since the double-sided pressure-sensitive adhesive sheet includes a conductive film of which at least one surface has a surface resistivity of 500Ω/□ or less, and the double-sided pressure-sensitive adhesive sheet is excellent in transparency since the double-sided pressure-sensitive adhesive sheet has a total light transmittance of 80% or more and a haze of 5% or less.

### BRIEF DESCRIPTION OF THE DRAWINGS

FIG. 1 is a schematic sectional view illustrating an embodiment of an electric capacitive type touch panel.

### DETAILED DESCRIPTION OF THE INVENTION

The double-sided pressure-sensitive adhesive sheet according to the present invention includes a conductive film of which at least one surface has a surface resistivity of 500Ω/□ or less, and pressure-sensitive adhesive layers. The ‘pressure-sensitive adhesive sheet’ in the present invention includes any forms such as a tape type pressure-sensitive adhesive and a sheet type pressure-sensitive adhesive, i.e., the ‘pressure-sensitive adhesive sheet’ is a generic term including the ‘pressure-sensitive adhesive sheet’ and ‘pressure-sensitive adhesive tape’.

The double-sided pressure-sensitive adhesive sheet according to the present invention is a pressure-sensitive adhesive sheet with a substrate in which a conductive film is a support.

The double-sided pressure-sensitive adhesive sheet according to the present invention is a double-sided pressure-sensitive adhesive sheet including a pressure-sensitive adhesive layers on both sides of the conductive film. The double-sided pressure-sensitive adhesive sheet according to the present invention is advantageous when laminating members which are components of optical members as described below during the manufacture of display devices such as liquid crystal displays (LCDs), or input devices used in combination with the display devices such as touch panels.

(Conductive Film)

The conductive film of the double-sided pressure-sensitive adhesive sheet according to the present invention is a film of which at least one surface has a surface resistivity of 500 Ω/□ or less. The conductive film not only plays a role of shielding electromagnetic waves, but also plays a role of core material having a key part in mechanical strength.

The conductive film of the double-sided pressure-sensitive adhesive sheet according to the present invention includes at least one layer of the conductive layer. The conductive film preferably includes a conductive layer and a film layer (a film substrate layer). The conductive film may includes other layers such as a hard coating layer, an antiglare layer, an undercoating layer and a pressure-sensitive adhesive layer, as necessary. In the conductive layer, the film layer is a layer composed of a film substrate.

The conductive film of the double-sided pressure-sensitive adhesive sheet according to the present invention may be a single-sided conductive type including a conductive layer on one side thereof, or a double-sided conductive type including conductive layers on both sides thereof. In the case of the double-sided conductive type, if electromagnetic waves are sufficiently shielded by the conductive layer formed on one side of the conductive film, the conductive layer formed on the other side of the conductive film may have other functions than the function of shielding electromagnetic waves. For instance, the functions other than the function of shielding electromagnetic waves may include functions of electrodes of a touch panel or display device or the like. If the display device and touch panel are laminated, the conductive layer formed on one side of the conductive film is used as a shield for shielding signals coming out of a display module, and the conductive layer formed on the other side of the conductive film is used as an electrode for detecting the location of the touch panel. In that case, the conductive layer functioning as the electromagnetic wave shield is preferably arranged so that the conductive layer and display module face each other.

The conductive film of the double-sided pressure-sensitive adhesive sheet according to the present invention may be a conductive film of which one surface has a surface resistivity of 500Ω/□ or less, or a conductive film of which both surfaces have a surface resistivity of 500Ω/□ or less. If the conductive layer formed on the other side of the conductive film is used as other functions than the function of shielding electromagnetic waves, the surface resistivity may be appropriately selected according to its use.

In the conductive film of the double-sided pressure-sensitive adhesive sheet according to the present invention, examples of material for a film layer (material for a film substrate) include plastic materials including polyester-based resins such as polyethylene terephthalate (PET); acrylic resins such as polymethyl (meth)acrylate (PMMA); polycarbonate; triacetyl cellulose (TAC); polysulfone; polyarylate; and cyclic olefin based polymers such as cyclic olefin based polymer with trade name of ‘ARTON’ manufactured by JSR Corporation and cyclic olefin based polymer with trade name of ‘ZEONOR’ manufactured by ZEON Corporation. The plastic materials are used either alone or in combination of two or more thereof.

Among others, a transparent substrate may be used as a film substrate constituting a film layer. For instance, the ‘transparent substrate’ may be a film substrate having a total light transmittance of 85% or more in a visible light wavelength range in accordance with JIS K 7361, more preferably a film substrate having a total light transmittance of 90% or more. Examples of the transparent substrate include polyester-based resin substrates such as polyethylene terephthalate (PET) substrate, and non-oriented film substrates such as trade names of ‘ARTON’ and ‘ZEONOR’. That is, it is preferable that the double-sided pressure-sensitive adhesive sheet according to the present invention preferably includes a conductive film of which at least one surface has a surface resistivity of 500Ω/□ or less, the conductive film including a conductive layer and a film layer having a total light transmittance of 85% or more in a visible light wavelength range in accordance with JIS K 7361 (for instance, polyester-based resin substrates such as PET substrate, and non-oriented film substrates).

A thickness of the film substrate is not particularly limited. For instance, the thickness of the film substrate is preferably 1 to 1,000 μm, more preferably 5 to 500 μm. The substrate film may be formed in any forms of a single layer or plural layers. Proper known/general surface treatment such as corona discharge treatment, physical treatment such as plasma treatment, and chemical treatment such as base coating treatment may be performed on the surface of the film substrate.

In the double-sided pressure-sensitive adhesive sheet according to the present invention, specific examples of the conductive film include films with deposition films of metal oxides (metal oxide-deposited films), and conductive material-coated films.

The metal oxide-deposited films include at least a film layer, and a metal oxide-deposited layer as a conductive layer. The metal oxide-deposited films are prepared by forming a metal oxide-deposited layer on at least one side of the film substrate by vacuum deposition or sputtering.

For instance, as the metal oxides forming the metal oxide-deposited layer, examples thereof include oxides of at least one metal selected from the group consisting of indium, tin, zinc, gallium, antimony, titanium, silicon, zirconium, magnesium, aluminum, gold, silver, copper, palladium and tungsten. ITO (indium-tin oxide, oxide of indium and tin) is preferably used among the metal oxides from the standpoints of transparency and conductivity.

The conductive material-coated films include at least a film layer and a conductive material-coated layer as a conductive layer. The conductive material-coated films include a conductive material-coated layer formed on at least one side of the film substrate by applying a liquid product such as solution, dispersion or paste containing conductive material to a process such as spin coating, printing, coating or dipping.

In the conductive material-coated films, examples of the conductive material constituting the conductive material-coated layer include metal particles, particularly metal nanoparticles with a nanometer-sized particle diameter, carbon nanotubes, and conductive polymers such as polythiophene, polyaniline, etc. The conductive materials may be used either alone or in combination of two or more thereof.

The conductive film in the double-sided pressure-sensitive adhesive sheet according to the present invention is preferably a metal oxide-deposited film (particularly ITO-deposited film) produced by forming a deposition film of metal oxides (particularly ITO) on at least one side of the film substrate using vacuum deposition or sputtering from the standpoint of productivity or cost.

For instance, as a commercially available ITO-deposited film, examples thereof include a conductive film with a trade name of ‘ELECRYSTA’, manufactured by Nitto Denko Corporation, and includes a layer structure of film layer (PET substrate layer)/conductive layer (ITO layer).

In the double-sided pressure-sensitive adhesive sheet according to the present invention, the thickness of the conductive layer of the conductive film (e.g., a metal oxide film of a metal oxide-deposited film or a conductive material-coated layer of a conductive material-coated film) is not particularly limited. However, if the conductive layer is too thin, there may be a problem in strength of the conductive layer, or it may be difficult to obtain a continuous thin film as the conductive layer. On the other hand, if the conductive layer is too thick, the thickness of the conductive layer may have an adverse effect on transparency of the conductive layer, and cracks may be easily formed in the conductive layer. Therefore, the conductive layer of the conductive film preferably has a thickness of 1 to 100 nm, more preferably 5 to 50 nm.

At least one surface of the conductive film in the double-sided pressure-sensitive adhesive sheet according to the present invention has a surface resistivity of 500Ω/□ or less, preferably 450Ω/□ or less, and more preferably 400Ω/□ or less in order to attenuate electromagnetic waves effectively.

In the double-sided pressure-sensitive adhesive sheet according to the present invention, a conductive film preferably has a surface resistivity of 1Ω/□ or more, and more preferably 10Ω/□ or more.

The surface resistivity is measured based on a dual-ring electrode method mentioned in JIS K 6911.

In the double-sided pressure-sensitive adhesive sheet according to the present invention, the conductive film may have high transparency. For instance, the conductive film may have a total light transmittance of 50% or more in a visible light wavelength range in accordance with JIS K 7361, and more preferably 80% or more. The conductive film preferably has a haze of 10% or less in accordance with JIS K 7136, more preferably 5% or less. The total light transmittance and haze of the conductive film can be measured using a haze meter (trade name of ‘HM-150’ manufactured by Murakami Color Research Laboratory Co., Ltd.).

In the double-sided pressure-sensitive adhesive sheet according to the present invention, although the thickness of the conductive film is not particularly limited, it is preferably 1 to 1,000 μm, more preferably 5 to 500 μm from the standpoint of transparency and strength.

(Pressure-Sensitive Adhesive Layer)

In the double-sided pressure-sensitive adhesive sheet according to the present invention, the pressure-sensitive adhesive layer is not particularly limited in so far as the pressure-sensitive adhesive sheet exhibits good adhesion to an adherend and the pressure-sensitive adhesive sheet has a total light transmittance of 80% or more and a haze of 5% or less. In the double-sided pressure-sensitive adhesive sheet according to the present invention, compositions of two pressure-sensitive adhesive layers on both sides may be the same as or different from each other. The double-sided pressure-sensitive adhesive sheet according to the present invention may include the pressure-sensitive adhesive layer on the conductive layer of the conductive film.

In the double-sided pressure-sensitive adhesive sheet according to the present invention, examples of pressure-sensitive adhesive for forming the pressure-sensitive adhesive layer include known pressure-sensitive adhesives such as acrylic pressure-sensitive adhesives, rubber-based pressure-sensitive adhesives, vinyl alkyl ether-based pressure-sensitive adhesives, silicone-based pressure-sensitive adhesives, polyester-based pressure-sensitive adhesives, polyamide-based pressure-sensitive adhesives, urethane-based pressure-sensitive adhesives, fluorine-based pressure-sensitive adhesives, and epoxy-based pressure-sensitive adhesives. These pressure-sensitive adhesives may be used either alone or in combination of two or more thereof. The pressure-sensitive adhesives may be pressure-sensitive adhesives having any forms, and examples thereof include solvent type pressure-sensitive adhesives, active energy ray-curable pressure-sensitive adhesives, and thermal fusion type pressure-sensitive adhesives (hot melt type pressure-sensitive adhesives).

Acrylic pressure-sensitive adhesive layers or polyester-based pressure-sensitive adhesive layers is preferably used among the pressure-sensitive adhesives in the double-sided pressure-sensitive adhesive sheet according to the present invention from the standpoint of transparency, processability and durability, and the acrylic pressure-sensitive adhesive is particularly preferably used. Namely, in the double-sided pressure-sensitive adhesive sheet according to the present invention, the acrylic pressure-sensitive adhesive layers or polyester-based pressure-sensitive adhesive layers is preferably used as the pressure-sensitive adhesive layers, and particularly the acrylic pressure-sensitive adhesive layers is preferably used.

In the double-sided pressure-sensitive adhesive sheet according to the present invention, pressure-sensitive adhesive layers preferably include 60 wt % or more (e.g., 60 to 100 wt %), of a base polymer, and more preferably 80 wt % or more (e.g., 80 to 100 wt %), based on the total weight of the pressure-sensitive adhesive layer.

Although the polyester-based pressure-sensitive adhesive layers are not particularly limited, a pressure-sensitive adhesive layer including a polyoxyalkylene-based polymer as a base polymer is preferable. Especially, the polyoxyalkylene-based polymer preferably has a repeating unit represented by the following chemical formula (I) in a main chain thereof.

—R₁—O— (1)
where R₁ is an alkylene group.

It is preferred that R₁ is a straight-chain or branched alkylene group having 1 to 14 carbon atoms, preferably 2 to 4 carbon atoms.

Specific examples of the repeating unit represented by the chemical formula (I) include —CH₂O—, —CH₂CH₂O—, —CH₂CH(CH₃)O—, —CH₂CH(CH₂CH₅)O—, —CH₂C(CH₃)₂O— and —CH₂CH₂CH₂CH₂O—. The backbone of main chains of the polyoxyalkylene-based polymer may consist of only one type of repeating unit or two or more types of repeating units. Particularly, polymers having —CH₂CH(CH₃)O— as a main repeating unit are preferable from the standpoint of availability and workability. Also, polymers having repeating units other than an oxyalkylene group may be included in the main chain thereof, wherein the sum of oxyalkylene units in the polymer is preferably 80 wt % or more, and more preferably 90 wt % or more.

Although a polyoxyalkylene-based polymer may be a straight-chain polymer, a branched polymer, or a mixture thereof, the polyoxyalkylene-based polymer may include 50 wt % or more of the straight-chain polymer in order to obtain good pressure-sensitive adhesion.

The acrylic pressure-sensitive adhesive layer is a pressure-sensitive adhesive layer containing as a base polymer an acrylic polymer formed by acrylic monomers as an essential monomer component The acrylic polymer is preferably an acrylic polymer formed by alkyl ester (meth)acrylate and/or alkoxyalkyl ester (meth)acrylate as essential monomer components. The term ‘(meth)acryl’ represents ‘acryl’ and/or ‘methacryl’, and the same applies to others.

Alkyl ester (meth)acrylate having a straight-chain or branched alkyl group (hereinbelow simply referred to as ‘alkyl ester (meth)acrylate’ in some cases) may be appropriately used as the alkyl ester (meth)acrylate. Examples of the alkyl ester (meth)acrylate include alkyl ester (meth)acrylate of which an alkyl group has 1 to 20 carbon atoms such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. The examples of alkyl ester (meth)acrylate may be used either alone or in combination of two or more thereof. Alkyl ester (meth)acrylate of which an alkyl group has 2 to 14 carbon atoms is preferable, and alkyl ester (meth)acrylate of which an alkyl group has 2 to 10 carbon atoms is more preferable among the examples of alkyl ester (meth)acrylate.

Although the alkoxyalkyl ester (meth)acrylate is not particularly limited, examples thereof include 2-methoxyethyl (meth)acrylate, 2-ethoxyethyl (meth)acrylate, methoxytriethyleneglycol (meth)acrylate, 3-methoxypropyl (meth)acrylate, 3-ethoxypropyl (meth)acrylate, 4-methoxybutyl (meth)acrylate and 4-ethoxybutyl (meth)acrylate. The alkoxyalkyl ester (meth)acrylate may be used either alone or in combination of two or more thereof.

Although the contents of essential monomer components forming the acrylic polymer (alkyl ester (meth)acrylate and/or alkoxyalkyl ester (meth)acrylate) are not particularly limited, they are preferably 30 wt % or more (e.g., 30 to 100 wt %), more preferably 50 wt % or more (e.g., 50 to 99 wt %), based on the total amount of the monomer components (100 wt %) forming the acrylic polymer from the standpoint of low temperature adhesion properties. If both alkyl ester (meth)acrylate and alkoxyalkyl ester (meth)acrylate are used as the monomer components, it is required that the total amount (content) of the alkyl ester (meth)acrylate and alkoxyalkyl ester (meth)acrylate should satisfy the above-mention ranges.

Examples of the monomer components forming the acrylic polymer may include polar group-containing monomers, multifunctional monomers and other copolymerizable monomers in addition to the acrylic monomers (alkyl ester (meth)acrylate and alkoxyalkyl ester (meth)acrylate with a straight-chain or branched alkyl group) as copolymer monomer components. For instance, such copolymerizable monomers are capable of improving pressure-sensitive adhesion properties or stress relaxation properties of the pressure-sensitive adhesion layer by improving cohesion force of the adhesion layer. The copolymer monomer components may be used either alone or in combination of two or more thereof.

Examples of the polar group-containing monomers include: carboxyl group-containing monomers such as (meth)acrylate, itaconic acid, maleic acid, fumaric acid, crotonic acid and anhydrides thereof (e.g., maleic anhydride); hydroxyl group-containing monomers such as vinyl alcohol, aryl alcohol, and hydroxyallyl (meth)acrylate such as 2-hydroxyethyl (meth)acrylate, 3-hydroxypropyl (meth)acrylate, 4-hydroxybutyl (meth)acrylate and 6-hydroxyhexyl (meth)acrylate; amide group-containing monomers such as (meth)acrylamide, N,N-dimethyl (meth)acrylamide, N-methylol (meth)acrylamide, N-methoxymethyl (meth)acrylamide, N-butoxymethyl (meth)acrylamide and N-hydroxyethyl acrylamide; amino group-containing monomers such as aminoethyl (meth)acrylate, dimethylaminoethyl (meth)acrylate and t-butyl aminoethyl (meth)acrylate; glycydyl group-containing monomers such as glycidyl (meth)acrylate and methylglycidyl (meth)acrylate; cyano group-containing monomers such as acrylonitrile and methacrylonitrile; heterocyclic ring-containing vinyl monomers such as N-vinyl piperidone, N-vinyl piperazine, N-vinyl pyrrole, N-vinyl imidazole, N-vinyl pyridine, N-vinyl pyrimidine and N-vinyl oxazole in addition to N-vinyl-2-pyrrolidone and (meth)acryloyl morpholine; sulfonate group-containing monomers such as sodium vinyl sulfonate; phosphate group-containing monomers such as 2-hydroxyethyl acryloyl phosphate; imide group-containing monomers such as cyclohexyl maleimide and isopropyl maleimide; and isocyanate group-containing monomers such as 2-methacryloyloxyethyl isocyanate.

As the polar group-containing monomers, among them, the carboxyl group-containing monomers, hydroxyl group-containing monomers, amino group-containing monomers, amide group-containing monomers and heterocyclic ring-containing vinyl monomers are preferred, and (meth)acrylate, 4-hydroxybutyl acrylate (4HBA), N-vinyl-2-pyrrolidone (NVP), and N-hydroxyethyl acrylamide (HEAA) are more preferred.

Although the contents of the polar group-containing monomers are not particularly limited, the contents of the polar group-containing monomers are preferably 30 wt % or less (e.g., 0.01 to 30 wt %), more preferably 1 to 15 wt %, and further more preferably 1 to 10 wt % based on the total amount of monomer components forming the acrylic polymer from the standpoint of suppressing deterioration of pressure-sensitive adhesion performance caused by decrease in cohesion force of the pressure-sensitive adhesive.

Examples of the multifunctional monomers include hexandiol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinyl benzene, epoxy acrylate, polyester acrylate and urethane acrylate.

Although the contents of the multifunctional monomers are not particularly limited, they are preferably 5 wt % or less (e.g., 0.001 to 5 wt %) based on the total amount of monomer components forming the acrylic polymer since cohesion force of the pressure-sensitive adhesive layer may be excessively increased and the stress relaxation property may be lowered if the contents of the multifunctional monomers are excessively high.

Examples of the other copolymerizable monomers (i.e., copolymerizable monomers other than the polar group-containing monomers and multifunctional monomers as described above) include: ester (meth)acrylate other than the above-mentioned polar group-containing monomers, polyfunctional monomers and alkyl ester (meth)acrylate, including ester (meth)acrylate having alicyclic hydrocarbon groups such as cyclopentyl (meth)acrylate, cyclohexyl (meth)acrylate and isobornyl (meth)acrylate, and ester (meth)acrylate having aromatic hydrocarbon groups such as phenyl (meth)acrylate; vinyl esters such as vinyl acetate and vinyl propionate; aromatic vinyl compounds such as styrene and vinyl toluene; olefins or dienes such as ethylene, butadiene, isoprene, and isobutylene; vinyl ethers such as vinyl alkyl ether; and vinyl chloride.

The acrylic polymer as the base polymer can be prepared by polymerizing the above-mentioned monomer components by a known/general polymerization method. Examples of the polymerization method of the acrylic polymer include a solution polymerization, an emulsion polymerization, a bulk polymerization and a polymerization by active-energy-ray irradiation such as an active-energy-ray polymerization or a photopolymerization. Among the above polymerization, the solution polymerization and active-energy-ray polymerization are preferable from the standpoint of transparency, water resistance and costs. Particularly when a relatively thick pressure-sensitive adhesive layer is formed, an active-energy-ray polymerization is preferable, and particularly a ultraviolet-ray polymerization performed by irradiating ultraviolet rays is preferable.

Examples of active energy rays irradiated during the active-energy-ray polymerization (photopolymerization) include ultraviolet rays or ionizing radiations such as an α-ray, a β-ray, a γ-ray, a neutron ray, and an electron ray. Particularly, the active energy rays may be the ultraviolet rays. Irradiation energy, irradiation time, and irradiation method of active energy rays are not particularly limited as far as photopolymerization initiators can be activated to cause the reaction of monomer components.

Various general solvents are used in the solution polymerization. Examples of these solvents include: organic solvents including esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methyl ethyl ketone and methyl isobutyl ketone. Such solvents may be used either alone or in combination of two or more thereof.

It is preferable to use polymerization initiators such as a thermal polymerization initiator or a photopolymerization initiator (photoinitiator) depending on the type of polymerization reaction in the production of an acrylic polymer. The polymerization initiators may be used either alone or in combination of two or more thereof.

The photopolymerization initiator is not particularly limited, and examples thereof may include a benzoin ether-based photopolymerization initiator, an acetophenon-based photopolymerization initiator, an α-ketol-based photopolymerization initiator, an aromatic sulfonylchloride-based photopolymerization initiator, a photoactive oxime-based photopolymerization initiator, a benzoin-based photopolymerization initiator, a benzyl-based photopolymerization initiator, a benzophenone-based photopolymerization initiator, a ketal-based photopolymerization initiator, and a thioxanthone-based photopolymerization initiator.

Examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethane-1-one and anisole methyl ether. Examples of the acetophenone-based photopolymerization initiator include 2,2-diethoxyacetophenone, 2,2-dimethoxy-2-phenylacetophenone, 1-hydroxycyclohexylphenylketone, 4-phenoxydichloroacetophenone and 4-(t-butyl)dichloroacetophenone. Examples of the α-ketol based photopolymerization initiator include 2-methyl-2-hydroxypropiophenone and 1-[4-(2-hydroxyethyl)phenyl]-2-methylpropane-1-one. Examples of the aromatic sulfonyl chloride-based photopolymerization initiator include 2-naphthalenesulfonyl chloride. Examples of the photoactive oxime-based photopolymerization initiator include 1-phenyl-1,1-propandion-2-(o-ethoxycarbonyl)-oxime. Examples of the benzoin-based photopolymerization initiator include benzoin. Examples of the benzyl-based photopolymerization initiator include benzyl. Examples of the benzophenone-based photopolymerization initiator include benzophenone, benzoyl benzoate, 3,3′-dimethyl-4-methoxybenzophenone, polyvinyl benzophenone and α-hydroxycyclohexyl phenylketone. Examples of the ketal-based photopolymerization initiator include benzyl dimethyl ketal. Examples of the thioxanthone-based photopolymerization initiator include thioxanthone, 2-chlorothioxanthone, 2-methyl thioxanthone, 2,4-dimethyl thioxanthone, isopropyl thioxanthone, 2,4-diisopropyl thioxanthone and dodecyl thioxanthone.

Although the amount of the photopolymerization initiator used is not particularly limited, it is preferably 0.005 to 1 part by weight based on 100 parts by weight of the total amount of monomer components forming an acrylic polymer.

Examples of the thermal polymerization initiator include: azo-based polymerization initiators such as 2,2′-azobisisobutyronitrile, 2,2′-azobis-2-methylbutyronitrile, dimethyl 2,2′-azobis(2-methylpropionate), 4,4′-azobis-4-cyanovaleric acid, azobisisovaleronitrile, 2,2′-azobis(2-amidinopropan)dihydrochloride, 2,2′-azobis[2-(5-methyl-2-imidazolin-2-yl)propan]dihydrochloride, 2,2′-azobis(2-methylpropionamidine)disulfate and 2,2′-azobis(N,N′-dimethyleneisobutylamidine)dihydrochloride; peroxide-based polymerization initiators such as dibenzoyl peroxide and ter-butyl permaleate; and redox-based polymerization initiators.

Although the amount of the thermal polymerization initiator used is not particularly limited, it is preferably 0.01 to 1 part by weight, more preferably 0.1 to 1 part by weight, based on 100 parts by weight of the total monomer components forming an acrylic polymer.

The pressure-sensitive adhesive layer of the double-sided pressure-sensitive adhesive sheet according to the present invention may include, as necessarily, known additives such as crosslinking agents, crosslinking accelerators, tackifiers (e.g., rosin derivative resin, polyterpene resin, petroleum resin and oil soluble phenolic resin), anti-aging agents, fillers, coloring agents (e.g., pigments and dyes), ultraviolet absorbers, antioxidants, chain transfer agents, plasticizers, softeners, surfactants and antistatic agents within the amount ranges in which characteristics of the present disposure are not impaired.

The crosslinking agent is capable of crosslinking a base polymer of the pressure-sensitive adhesive layer if a crosslinking agent is used in the pressure-sensitive adhesive layer of the double-sided pressure-sensitive adhesive sheet according to the present invention. For instance, if the pressure-sensitive adhesive layer of the double-sided pressure-sensitive adhesive sheet according to the present invention is an acrylic pressure-sensitive adhesive layer, the crosslinking agent is capable of increasing cohesion force of the pressure-sensitive adhesive layer further more by crosslinking the acrylic polymer that is the base polymer. Therefore, it is preferable that the pressure-sensitive adhesive layer includes a crosslinking agent in the double-sided pressure-sensitive adhesive sheet according to the present invention.

Although examples of the crosslinking agent are not particularly limited and known crosslinking agents may be widely used, it is preferable to use isocyanate-based crosslinking agents or epoxy-based crosslinking agents. The crosslinking agents may be used either alone or in combination of two or more thereof.

Examples of the isocyanate-based crosslinking agents include lower aliphatic polyisocyanates such as 1,2-ethylene diisocyanate, 1,4-butylene diisocyanate and 1,6-hexamethylene diisocyanate; alicyclic polyisocyanates such as cyclopentylene diisocyanate, cyclohexylene diisocyanate, isophorone diisocyanate, hydrogenated tolylene diisocyanate and hydrogenated xylene diisocyanate; and aromatic polyisocyanates such as 2,4-tolylene diisocyanate, 2,6-tolylene diisocyanate, 4,4′-diphenylmethane diisocyanate and xylene diisocyanate. The examples thereof may include an adduct of trimethylolpropane/tolylene diisocyanate (trade name of ‘Coronate L’, manufactured by Nippon Polyurethane Industry Co., Ltd.); and an adduct of trimethylolpropane/hexamethylene diisocyanate (trade name of ‘Coronate HL’, manufactured by Nippon Polyurethane Industry Co., Ltd.).

Examples of the epoxy-based crosslinking agents include epoxy-based resins having two or more epoxy groups in molecules thereof such as N,N,N′,N′-tetraglycidyl-m-xylenediamine, diglycidylaniline, 1,3-bis(N,N-diglycidylaminomethyl)cyclohexane, 1,6-hexandioldiglycidylether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylol propane polyglycidyl ether, adipic acid diglycidyl ester, o-phthalic acid diglycidyl ester, triglycidyl-tris(2-hydroxyethyl)isocyanurate, resorsin type diglycidyl ether and bisphenol-S-diglycidylether. As commercially available products thereof, examples thereof include a trade name of ‘Tetrad-C’ manufactured by Mitsubish Gas Chemical Company Inc.

The amount of the crosslinking agents used is not particularly limited. However, it is preferably 0.001 to 20 parts by weight, more preferably 0.01 to 10 parts by weight, based on 100 parts by weight of the total monomer components forming an acrylic polymer. If an isocyanate-based crosslinking agent is used among the crosslinking agents, the amount of the isocyanate-based crosslinking agent used is preferably 0.01 to 20 parts by weight, more preferably 0.01 to 10 parts by weight, and further more preferably 0.01 to 3 parts by weight, based on 100 parts by weight of the total monomer components forming an acrylic polymer. If an epoxy based crosslinking agent is used, the amount of the epoxy based crosslinking agent used is preferably 0.001 to 5 parts by weight, more preferably 0.01 to 5 parts by weight, based on 100 parts by weight of the total monomer components forming an acrylic polymer.

A pressure-sensitive adhesive layer of the double-sided pressure-sensitive adhesive sheet according to the present invention is formed by known/general methods for forming the pressure-sensitive adhesive layer. The forming methods vary depending on polymerization methods of a base polymer. Although the forming methods are not particularly limited, examples thereof include the following methods of: (1) coating on the conductive film or release liner a composition (e.g., a pressure-sensitive adhesive composition or active-energy-ray cuarable pressure-sensitive adhesive composition) including a mixture of monomer components (i.e., ‘monomer mixture’), forming a base polymer (e.g., an acrylic polymer) or a ‘partially polymerized product thereof’, and additives such as a photopolymerization initiator added as occasion demands, and irradiating active energy rays to the composition-coated conductive film or release liner, thereby forming a pressure-sensitive adhesive layer; and (2) coating on the conductive film or release liner a composition (e.g., a pressure-sensitive adhesive composition or solvent type pressure-sensitive adhesive composition) (solution) including a base polymer, solvent, and additives added as occasion demands, and drying and/or curing the composition-coated conductive film or release liner, thereby forming a pressure-sensitive adhesive layer. Heating and drying steps may be performed in the methods (1) and (2) if necessary. The ‘monomer mixture’ means a mixture consisting of monomer components forming a base polymer. The ‘partially polymerized product thereof’ means a composition in which one or more of components in the monomer mixture are partially polymerized. The ‘pressure-sensitive adhesive composition’ also includes a ‘composition for forming the pressure-sensitive adhesive layer’.

In the coating step in the methods for forming the pressure-sensitive adhesive layer, known coating steps can be used, and customary coaters such as a gravure roll coater, a reverse roll coater, a kiss roll coater, a dip roll coater, a bar coater, a knife coater, a spray coater, a comma coater, and a direct coater can be used.

Although the thickness of the pressure-sensitive adhesive layer in the double-sided pressure-sensitive adhesive sheet according to the present invention is not particularly limited, it is preferably 1 to 500 μm, more preferably 12 to 250 μm, and further more preferably 15 to 100 μm. The pressure-sensitive adhesive layers on both sides of the double-sided pressure-sensitive adhesive sheet according to the present invention may have thicknesses that are the same as each other, or different from each other.

(Release Liner)

The pressure-sensitive adhesive layer surfaces (pressure-sensitive adhesion faces) of the double-sided pressure-sensitive adhesive sheet according to the present invention may be protected by a release liner (separator) until they are used. The respective pressure-sensitive adhesion faces of the pressure-sensitive adhesive sheet may be protected by two release liners, or may be protected in a roll typo wound form by a release liner of which both sides are formed as release faces. The release liner is used as protecting material of the pressure-sensitive adhesive layer, and is released when it is laminated to an adherend. The release liner may be optionally provided.

General release paper may be used as the release liner. Although the release liner is not particularly limited, examples thereof include a substrate with a release-treated layer, a low adhesion substrate made of a fluorine-based polymer and a low adhesion substrate made of a non-polar polymer.

Examples of the substrate with the release-treated layer (substrate for release liners) include plastic films or papers of which surfaces are treated by release treating agents such as a silicone-based release treating agent, a long chain alkyl-based release treating agent, fluorine-based release treating agent, and molybdenum sulfate. Examples of the fluorine-based polymer of a low adhesion substrate made of a fluorine-based polymer include polytetrafluoroethylene, polychlorotrifluoroethylene, polyvinyl fluoride, polyvinylidene fluoride, tetrafluoroethylene-hexafluoropropylene copolymer and chlorofluoroethylene-vinylidene fluoride copolymer. Examples of the non-polar polymer of a low adhesion substrate made of a non-polar polymer include olefin-based resins such as polyethylene and polypropylene.

The release liner may be formed by know/general methods. The thickness of the release liner are not particularly limited.

The double-sided pressure-sensitive adhesive sheet according to the present invention has a total light transmittance (total light transmittance in a visible light wavelength range in accordance with JIS K 7361) of 80% or more, preferably 90% or more. The double-sided pressure-sensitive adhesive sheet according to the present invention has a haze of 5% or less in accordance with JIS K 7136, more preferably 1.5% or less. For instance, the total light transmittance and haze of the pressure-sensitive adhesive sheet can be measured using a haze meter (trade name of ‘HM-150’, manufactured by Murakami Color Research Laboratory Co., Ltd.) in a state that the pressure-sensitive adhesive sheet is laminated to the slide glass.

Since the double-sided pressure-sensitive adhesive sheet according to the present invention has a good shielding effect since the double-sided pressure-sensitive adhesive sheet includes a conductive film, thereby attenuating electromagnetic waves (noises and magnetic wave noises). The double-sided pressure-sensitive adhesive sheet according to the present invention has excellent transparency since it has a total light transmittance of 80% or more and a haze of 5% or less. The double-sided pressure-sensitive adhesive sheet according to the present invention is also excellent in visibility or optical properties. The shielding effect is an indicator of indicating to a degree of which the double-sided pressure-sensitive adhesive sheet is capable of attenuating electromagnetic wave energy of an incident electric field or incident magnetic field.

Although the shielding effect is not particularly limited in the double-sided pressure-sensitive adhesive sheet according to the present invention, the shielding effect is preferably 1 to 100 dB, more preferably 10 to 90 dB, and further more preferably 10 to 70 dB at a frequency of 10 to 300 MHz from the standpoint that the double-sided pressure-sensitive adhesive sheet effectively obtains the shielding effect when the double-sided pressure-sensitive adhesive sheet according to the present invention is used in display devices such as liquid crystal displays (LCDs), or input devices such as touch panels which are used in combination with the display devices.

If a film substrate with high transparency and surface resistivity such as a PET film substrate is used instead of a conductive film in the double-sided pressure-sensitive adhesive sheet according to the present invention, the shielding effect is generally about 0 to 10 dB at a frequency of 10 to 300 MHz.

Examples of a measuring device capable of measuring the shielding effect of the double-sided pressure-sensitive adhesive sheet according to the present invention include a shielding effect measuring device (trade name of “TR-17301”, manufactured by Advantest Corporation). Specifically, the shielding effect is determined by inserting a pressure-sensitive adhesive sheet as a measuring material between cells, transmitting noises from a transmission antenna to generate electromagnetic waves, receiving an electric field passing to through the pressure-sensitive adhesive sheet by a receiving antenna, and measuring attenuation of the electromagnetic waves due to the pass of the pressure-sensitive adhesive sheet.

Although the thickness of the double-sided pressure-sensitive adhesive sheet according to the present invention is not particularly limited, it is preferably 3 to 2,000 μm, more preferably 12 to 250 μm from the standpoint that a pressure-sensitive adhesion function and an electromagnetic wave shielding function should be compatible in the double-sided pressure-sensitive adhesive sheet according to the present invention.

The double-sided pressure-sensitive adhesive sheet according to the present invention can be produced by known methods. For instance, the double-sided pressure-sensitive adhesive sheet according to the present invention can be produced by forming the pressure-sensitive adhesive layers on both sides of a conductive film using the above-described known/general methods for forming a pressure-sensitive adhesive layer.

The double-sided pressure-sensitive adhesive sheet according to the present invention is appropriately applied for shielding electromagnetic waves. For instance, the double-sided pressure-sensitive adhesive sheet according to the present invention is preferably used as an electromagnetic wave shielding material which is laminated to an object to exhibit shielding effect from a desired part of the object, or is preferably applied to connections requiring absorption or shielding of electromagnetic waves with the purposes of preventing misoperation of electronic equipment or electronic circuit boards due to electromagnetic waves, protecting human body from electromagnetic waves, preventing leakage of information from the inside to the outside a building, and preventing diffused reflection of electromagnetic waves within a building.

The double-sided pressure-sensitive adhesive sheet according to the present invention is preferably applied for laminating optical members (for laminating optical members), or for manufacturing devices (optical devices) such as display devices (image display devices) or input devices.

The optical members refer to members having optical properties such as a polarized property, a photorefractivity property, a light scattering property, a light reflective property, a light transmitting property, a light absorbing property, a light diffractive property, an optical rotation property and visibility.

Although the optical members are not particularly limited as far as they are members having optical properties, examples thereof include members constituting devices (optical devices) such as display devices (image display devices) and input devices, or members used in the devices. Examples of the optical members include a polarizing plate, a wave plate, a retardation plate, an optical compensation film, a brightness enhancing film, a light guide plate, a reflective film, an anti-reflective film, a transparent conductive film (ITO film etc), a design film, a decoration film, a surface protection film, a prism, lens, a color filter, a transparent substrate, and members in which these are laminated. The ‘plate’ and ‘film’ include plate form, film form and sheet form, and examples of the ‘polarizing plate’ include ‘a polarizing film’ and ‘a polarizing sheet’.

Examples of the display devices include a liquid crystal display, an organic EL (electroluminescence), a PDP (Plasma Display Panel), and an electronic paper. Examples of the input devices include touch panels (particularly such as an electric capacitive type touch panel etc).

Although examples of the optical members are not particularly limited, examples thereof include members formed of an acryl resin, polycarbonate, polyethylene terephthalate, glass, and metal film films (e.g., a sheet, film or plate type of members). The ‘optical members’ in the present invention may include members paying a role of decoration or protection while maintaining visibility of a display device or input device that is an adherent as described above, e.g., a design film, a decorating film, and a surface protection film.

Although embodiments of laminating optical members by the double-sided pressure-sensitive adhesive sheet according to the present invention are not particularly limited, they may include (1) an embodiment of interposing the double-sided pressure-sensitive adhesive sheet according to the present invention between the optical members to laminate the optical members to each other, and (2) an embodiment of laminating an optical member to any members other than the optical member through the double-sided pressure-sensitive adhesive sheet according to the present invention. Since the conductive films of the double-sided pressure-sensitive adhesive sheet according to the present invention correspond to optical members when the conductive films exhibit optical properties, embodiments of laminating the optical members by the double-sided pressure-sensitive adhesive sheet according to the present invention further include (3) an embodiment of laminating the double-sided pressure-sensitive adhesive sheet according to the present invention to optical members or any members other than the optical members.

A pressure-sensitive adhesion type optical member including a pressure-sensitive adhesive layer formed on at least one side of the optical member may be obtained by laminating the double-sided pressure-sensitive adhesive sheet according to the present invention to the surface of an optical member.

Particularly, the double-sided pressure-sensitive adhesive sheet according to the present invention may be desirably applied for laminating members constituting an electric capacitive type touch panel.

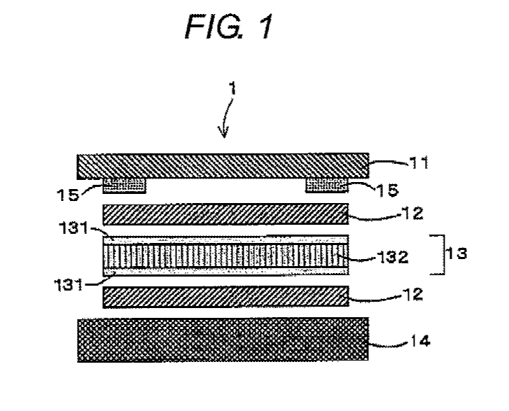

As a more specific example, FIG. 1 shows a schematic sectional view illustrating an embodiment of an electric capacitive type touch panel formed by laminating members using the double-sided pressure-sensitive adhesive sheet according to the present invention. In FIG. 1, 1 represents an electric capacitive type touch panel, 11 represents a cover glass, 12 represents a pressure-sensitive adhesive sheet (double-sided pressure-sensitive adhesive sheet), 13 represents an ITO glass substrate, 131 represents an ITO film (transparent conductive film), 132 represents a glass plate, 14 represents a liquid crystal display, and 15 represents a printing part. Electric capacitive type touch panel 1 includes cover glass 11 and ITO glass substrate 13 laminated in a state that pressure-sensitive adhesive sheet 12 is interposed between cover glass 11 and ITO glass substrate 13, and ITO glass substrate 13 and liquid crystal display 14 laminated in a state that pressure-sensitive adhesive sheet 12 is interposed between ITO glass substrate 13 and liquid crystal display 14. Although examples of electric capacitive type touch panel 1 may include a touch panel type in which ITO film 131 is formed on both sides of ITO glass substrate 13, they may generally include a touch panel type in which ITO film is formed on one side of ITO glass substrate.

In an electric capacitive type touch panel, although the electric capacitive type touch panel of FIG. 1 may include ITO film (transparent conductive film) formed on glass substrate, it may also include ITO film (transparent conductive film) formed on a plastic film such as a PET film.

Since such an electric capacitive type touch panel includes the double-sided pressure-sensitive adhesive sheet according to the present invention, misoperation in sensing of the touch panel is suppressed by electromatic shielding effect of the pressure-sensitive adhesive sheet to obtain excellent operating stability, although signals coming out of a liquid crystal display (display module) are noised. The electric capacitive type touch panel has also excellent visibility due to high transparency of the pressure-sensitive adhesive sheet.

### EXAMPLES

Hereinafter, the present invention will be described in more detail with reference to the following examples. However, the following examples are provided for illustrative purposes only, and the scope of the present invention should not be limited thereto in any manner.

(Acrylic Pressure-Sensitive Adhesive Sheet)

An acrylic polymer solution was obtained by dissolving 95 parts by weight of butyl acrylate, 5 parts by weight of acrylic acid and 0.4 parts by weight of azobisisobutyronitrile into 100 parts by weight of ethyl acetate and reacting the mixture at 60° C. under stirring.

3 parts by weight (converted into the solid content) of an isocyanate based crosslinking agent (trade name of “Coronatel”, manufactured by Nippon Polyurethane Industry Co., Ltd.) was mixed with the acrylic polymer solution to prepare a pressure-sensitive adhesive composition (a solvent type pressure-sensitive adhesive composition).

The pressure-sensitive adhesive composition was coated on a separator (release liner), and the pressure-sensitive adhesive composition coated on the separator was heated and dried to obtain an acrylic pressure-sensitive adhesive sheet (including a structure of pressure-sensitive adhesive layer/separator), wherein the pressure-sensitive adhesive layer had a thickness of 25 μm.

### Example 1

As a conductive film, a transparent conductive film (an ITO-deposited film, trade name of “Elecrysta V270L-TFMP”, thickness: 180 manufacture by Nitto Denko Corporation) was used.

The acrylic pressure-sensitive adhesive sheet was laminated to both sides of the conductive film respectively to produce a double-sided pressure-sensitive adhesive sheet (including a structure of separator/pressure-sensitive adhesive layer (thickness: 25 μm)/conductive film (thickness: 180 μm)/pressure-sensitive adhesive layer (thickness: 25 μm)/separator).

### Example 2

As a conductive film, a transparent conductive film (an TTO-deposited film, trade name of “Elecrysta V270L-THMP”, thickness: 180 μm, manufactured by Nitto Denko Corporation) was used.

The acrylic pressure-sensitive adhesive sheet was laminated to both sides of the conductive film respectively to produce a double sided adhesive sheet (including a structure of separator/adhesive layer (thickness: 25 μm)/conductive film (thickness: 180 μm)/adhesive layer (thickness: 25 μm)/separator).

(Evaluation)

Surface resistivity of films used, total light transmittance and haze of pressure-sensitive adhesive sheets, and shielding effects of the pressure-sensitive adhesive sheets were measured with respect to the respective examples. Thereafter, measurement results were shown in Table 1.

(Method of Measuring Surface Resistivity of the Films)

The surface resistivity was measured in accordance with a dual-ring electrode method mentioned in JIS K 6911 with respect to surfaces of the films used in the examples. A resistivity meter (“Hiresta-UP, MCP-HT450”, manufactured by Mitsubishi Chemical Analytech Co., Ltd.) was used in the measurement of the surface resistivity. The measurement was performed on both sides of the films, and lower surface resistivity of the films was determined as surface resistivity of the films.

(Methods of Measuring Total Light Transmittance and Haze)

Test specimens (including a structure of pressure-sensitive adhesive sheet/slide glass) were prepared by removing the separator on one side from double-sided pressure-sensitive adhesive sheets, laminating to the slide glass (trade name of “S-1111”, total light transmittance: 91.8% and haze: 0.4%, manufactured by Matsunami Glass Industrial Ltd.), and removing the separator on the other side from the double-sided pressure-sensitive adhesive sheets.

Total light transmittance and haze of the test specimens were measured by using a haze meter (trade name of “HM-150”, manufactured by Murakami Color Research Laboratory Co., Ltd.).

(Shielding Effect)

Shielding effect of pressure-sensitive adhesive sheets was measured using a shielding effect measuring device (trade name of “TR-17301”, manufactured by Advantest Corporation). The shielding effect was carried out after releasing separators from both sides of the pressure-sensitive adhesive sheets.

TABLE 1

| | Surface | Shielding effect [dB] | | Total light | |
|---|---|---|---|---|---|
| | resistivity | Frequency | Frequency | transmittance | Haze |
| | [Ω/□] | 10 MHz | 100 MHz | [%] | [%] |
| Example 1 | 300 | 32 | 18 | 92 | 1.0 |
| Example 2 | 100 | 32 | 28 | 92 | 1.0 |

While the invention has been described in detail and with reference to specific embodiments thereof, it will be apparent to one skilled in the art that various changes and modifications can be made therein without departing from the spirit and scope thereof.

This application is based on Japanese Patent Application No. 2010-205422 filed on Sep. 14, 2010, and the entire subject matter of which is incorporated herein by reference.

The present invention provides the following double-sided pressure-sensitive adhesive sheet.

(1) A double-sided pressure sensitive adhesive sheet, which comprises a conductive film and pressure-sensitive adhesive layers on both sides of the conductive film, and has a total light transmittance of 80% or more and a haze of 5% or less, wherein at least one surface of the conductive film has a surface resistivity of 500Ω/□ or less.

(2) The double-sided pressure-sensitive adhesive sheet according to (1), wherein the conductive film comprises a conductive layer and a film substrate layer.

(3) The double-sided pressure-sensitive adhesive sheet according to (1) or (2), which has a thickness of 3 to 2,000 μm.

(4) The double-sided pressure-sensitive adhesive sheet of according to any one (1) to (3), wherein the double-sided pressure-sensitive adhesive sheet which is used for laminating an optical member.

### DESCRIPTION OF REFERENCE NUMERALS AND SIGNS

1: Electric capacitive type touch panel
11: Cover glass
12: Pressure-sensitive adhesive sheet
13: ITO glass substrate
131: ITO film
132: Glass plate
14: Liquid crystal display
15: Printing part

What is claimed is:

1. A double-sided pressure-sensitive adhesive sheet, which comprises a conductive film and pressure-sensitive adhesive layers on both sides of the conductive film, and has a total light transmittance of 80% or more and a haze of 5% or less, wherein at least one surface of the conductive film has a surface resistivity of 500Ω/□ or less.

2. The double-sided pressure-sensitive adhesive sheet according to claim 1, wherein the conductive film comprises a conductive layer and a film substrate layer.

3. The double-sided pressure-sensitive adhesive sheet according to claim 1, which has a thickness of 3 to 2,000 μm.

4. The double-sided pressure-sensitive adhesive sheet according to claim 2, which has a thickness of 3 to 2,000 μm.

5. The double-sided pressure-sensitive adhesive sheet according to claim 1 which is used for laminating an optical member.

6. The double-sided pressure-sensitive adhesive sheet according to claim 2, which is used for laminating an optical member.

7. The double-sided pressure-sensitive adhesive sheet according to claim 3, which is used for laminating an optical member.

8. The double-sided pressure-sensitive adhesive sheet according to claim 4, which is used for laminating an optical member.
